(19) United States
(12) Patent Application Publication
(10) Pub. No.: US 2008/0240007 A1
(43) Pub. Date: Oct. 2, 2008

(54) INTER-RING FAIRNESS CONTROL METHOD AND RPR NODE DEVICE

(76) Inventor: MASAHIKO TSUCHIYA, Tokyo (JP)

Correspondence Address: Jackson Chen,;NEC Corporation of America, 6535 N. State Hwy 161, Irving, TX, 75039, US

(21) Appl. No.: 12/054,912

(22) Filed: Mar. 25, 2008

(30) Foreign Application Priority Data
Mar. 27, 2007 (JP) 2007-081401

(51) Int. Cl. H04Q 7/00

(52) U.S. Cl. 370/310

(57) ABSTRACT

The fairness of communication traffic guaranteed within an RPR ring is guaranteed also at a ring interconnection. Transmit weight information used for fairness control is extracted from RPR control information in an arrival packet. In addition to this transmit weight information, a source address, a service class, a fairness bit, and a ring transmit direction are also extracted. If the packet has a fairness bit of “0,” the packet is temporarily stored in an output queue by service class. If the packet has a fairness bit of “1,” the packet is weighted by source and ring transmit direction, based on the transmit weight information, and is temporarily stored in an output queue by source and ring transmit direction. Reading of packets from the output queue by service class is performed prior to reading of packets from the output queue by source and ring transmit direction.

This application is based upon and claims the benefit of priority from Japanese Patent Application No. 2007-081401, filed on Mar. 27, 2007, the disclosure of which is incorporated herein in its entirety by reference.

### BACKGROUND OF THE INVENTION

1. Field of the Invention

The present invention relates to a communication network in which a plurality of packet ring networks are interconnected and in particular fairness control techniques in packet transmission between packet ring networks based on RPR (Resilient Packet Ring: IEEE 802.17) protocol or the like.

2. Description of the Related Art

For simplicity, it is assumed that adjacent ring networks (here, two RPR rings) are interconnected, each RPR ring having a plurality of RPR node devices connected in a ring topology.

As shown in FIG. 1, RPR ring 10 and RPR ring 20 are interconnected through a ring interconnecting point 30. Communications between these RPR rings 10 and 20 are performed through the ring interconnecting point 30.

As known well, IEEE 802.17 specifies fairness control to be carried out within a single RPR ring. For example, Japanese Patent Application Unexamined Publication No. P2005-151558A discloses a bandwidth allocation method using RPR fairness mechanism.

However, IEEE 802.17 does not specify any fairness control to be carried out between RPR rings interconnected. A conceivable solution to inter-ring fairness control is shown in FIG. 2.

Referring to FIG. 2, an RPR node device 12 is connected to the RPR ring 10 by an RPR port 11 and is connected to the RPR ring interconnecting point 30 by a ring interconnection port 13. when the RPR port 11 outputs communication traffic that has been transported over the RPR ring 10, the RPR node device 12 outputs it to the RPR ring interconnecting point 30, in accordance with the order of transport over the RPR ring 10. In such a structure, a conceivable solution to inter-ring fairness control may be implemented by a single output queue 12.1 and a single communication data reader 12.2 in the RPR node device 12.

Another conceivable solution is shown in FIG. 3. A RPR node device 14 as shown in FIG. 3 may be composed of an existing RPR node device with the addition of an output control function of a general bridge. Control variations having such an additional function may be disclosed in the followings: Japanese Patent Application Unexamined Publication Nos. P2001-186181A, P2005-210606A, P2005-323230A, P2007-13462A, and HEI 11-32078.

Referring to FIG. 3, the RPR node device 14 may be provided with a CoS-based traffic controller 15 and a communication data reader 16. The CoS-based traffic controller 15 performs priority control on communication traffic on a basis of the level of priority (CoS: Class of Service) defined by the Ethernet™ standards, not on a basis of the fairness among source RPR node devices on the RPR ring 10.

However, according to the technique as shown in FIG. 2, data is output to the RPR ring interconnecting point 30 in the order of arrival at the RPR node device 14. Accordingly, fairness control of communication traffic based on a fairness bit cannot be performed on a source-device basis or on a service-class basis, which is carried out within the RPR ring 10.

On the other hand, according to the technique as shown in FIG. 3, fairness control is not performed on source-device basis. Therefore the fairness defined in RPR cannot be implemented.

As for inter-ring connecting method, Japanese Patent Application Unexamined Publication No. P2006-262169A discloses a system interconnecting a plurality of RPR rings to allow high-speed failure protection and minimized failure range by resetting a ttl (time-to-live) of a braodcast frame to be relayed to another ring so that a predetermined point between the inter-ring connection device itself and another identical inter-ring connection device opposed within a ring to be relayed is a cleave point. However, P2006-262169A is silent on the inter-ring fairness control.

As described before, a RPR ring provides fairness control of traffic among source RPR node devices within an individual RPR ring. This fairness control provides such functionality that even when communication congestion occurs in an RPR ringlet of the RPR ring, each RPR node device fairly outputs communication traffic to the RPR ring, thereby avoiding an unfair communications state in which only the outputs from a specific RPR node device are transported over the RPR ring.

Again, in the RPR standards, there is no mention of fairness control of communication traffic as described above in the case where a plurality of RPR rings are interconnected. Accordingly, when scaling up a network by interconnecting a plurality of RPR rings to make a big-scale communications network structure, there arises a problem that the fairness of communication traffic is impaired.

### SUMMARY OF THE INVENTION

The present invention is made in such a background, and an object thereof is to provide an RPR node device, a fairness control method, and an RPR communications system which can guarantee the fairness of communication traffic that is guaranteed within an RPR ring, even at a ring interconnection in a communications network in which a plurality of RPR ring systems are interconnected.

According to the present invention, in a device for transferring packets from a first RPR network to a second RPR network, wherein the first and second RPR networks are interconnected through the device, the followings are provided:

an information extractor for extracting RPR control information including transmit weight information used for fairness control from RPR control information of a packet received from the first RPR network;

a first queue section for temporarily storing first packets ineligible for fairness control by service class;

a second queue section for temporarily storing second packets eligible for fairness control by source device and ring transmit direction on the first RPR network, wherein transmission ratios of the second packets are weighted according to the transmit weight information extracted from the second packets; and

a packet reader for reading packets from the first queue section taking priority over the second queue section.

One of advantages of the present invention is that fairness control as performed within the first RPR network can also be accomplished at an RPR ring interconnecting point to the second RPR network, because the RPR node device located at the RPR ring interconnecting point performs fairness control on data traffic that is eligible for the fairness control defined by RPR standards.

### BRIEF DESCRIPTION OF THE DRAWINGS

FIG. 1 is a diagram showing an example of interconnected RPR rings using a conventional RPR node device.

FIG. 2 is a diagram of the configuration of a conventional RPR node device.

FIG. 3 is a diagram of the configuration of a conventional RPR node device with the addition of an output control function of a general bridge.

FIG. 4 is a diagram showing an exemplary communications network to which an exemplary embodiment of the present invention is applied.

FIG. 5 is a diagram showing the configuration of an RPR node device accommodating a ring interconnecting point, according to the exemplary embodiment of the present invention.

FIG. 6A is a diagram of an RPR control frame.

FIG. 6B is a diagram showing examples of the information in a “ttl” field, a “base Control” field, and a “da” field.

FIG. 6C is a diagram showing examples of the information in a “control Type” field.

FIG. 6D is a diagram showing examples of the information in a “control Data Unit” field.

FIG. 6E is a diagram showing an example of the information in a “type Length Value” field of the “control Data Unit” field.

FIG. 6F is a diagram showing definition values of a “type” in the “type Length Value” field.

FIG. 6G is a diagram of an example of the transmit weight information in an “att Data Unit” field of the “control Data Unit” field.

FIG. 7A is a diagram showing an RPR data frame.

FIG. 7B is a diagram showing an example of “SC,” “FE,” and “ri” sub-fields of a “base Control” field.

FIG. 7C is a diagram showing exemplary values of ring transmit directions (ri).

FIG. 8 is a flow chart showing a procedure of fairness control operation according to the present exemplary embodiment of the present invention.

FIG. 9 is a diagram of the configuration of an RPR node device according to another exemplary embodiment of the present invention.

FIG. 10 is a diagram showing another example of a communications network according to the above exemplary embodiments of the present invention.

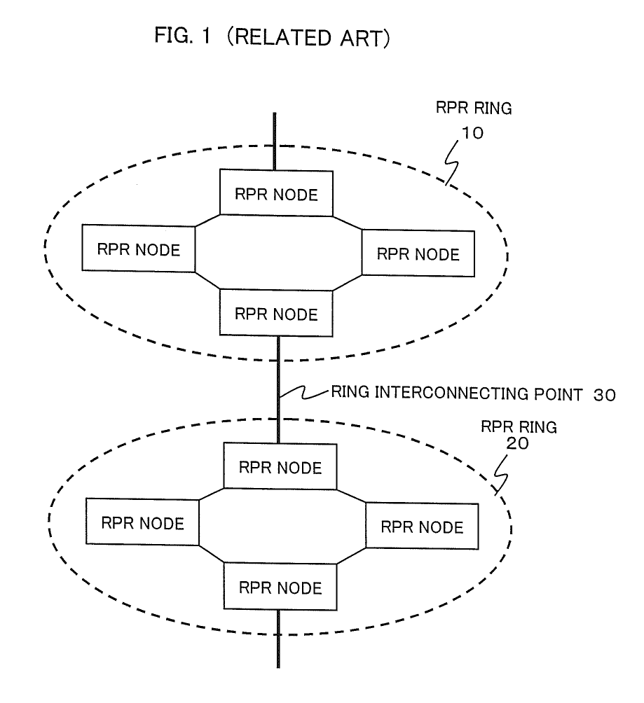

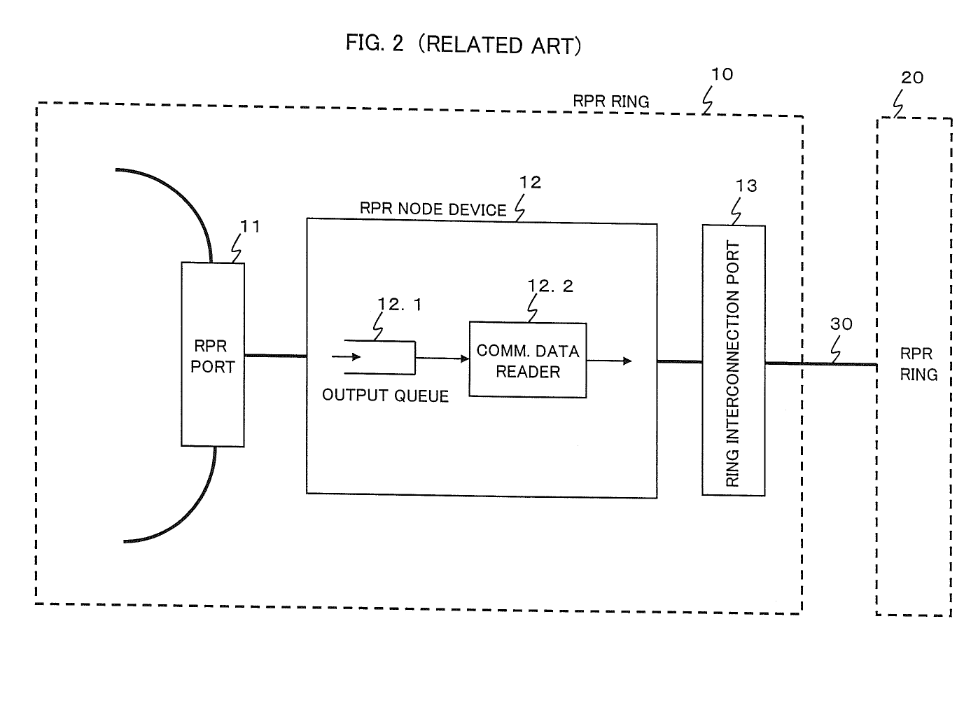

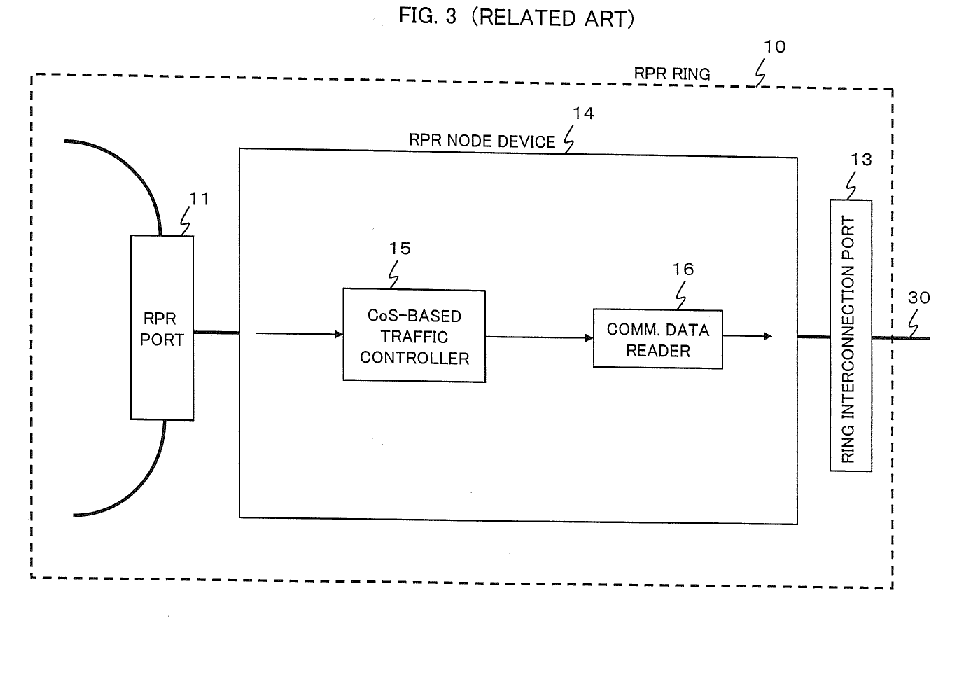

### DETAILED DESCRIPTION OF THE PREFERRED EMBODIMENTS

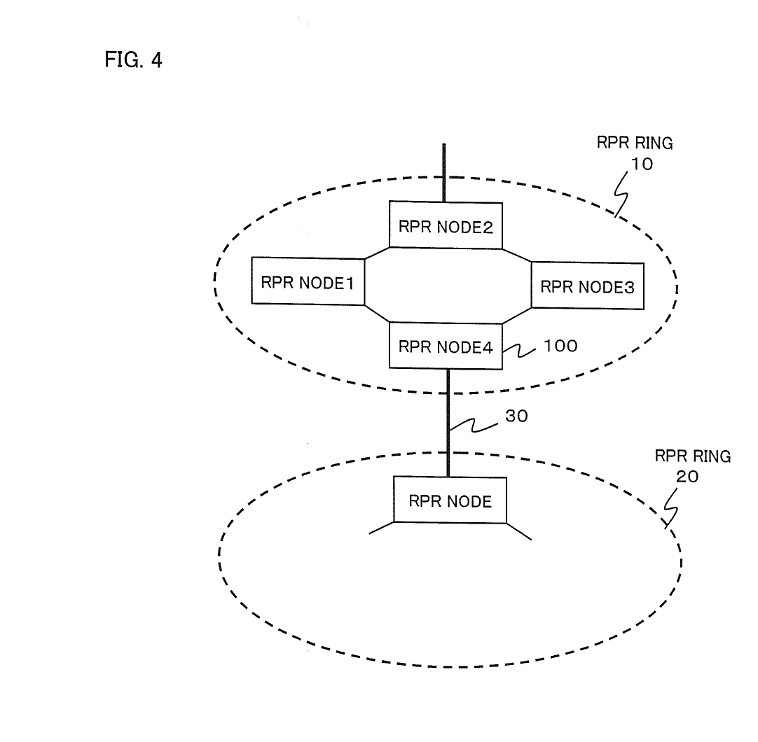

As shown in FIG. 4, it is assumed that RPR node devices NODE1 to NODE4 are included in an RPR ring 10 and the RPR node device 100 (NODE4) has an inter-ring connecting point 30 to another RPR ring 20. Hereinafter, the RPR node device according to an exemplary embodiment of the present invention will be described.

### 1. First Exemplary Embodiment

### 1.1) Structure of Ring-Interconnecting RPR Node

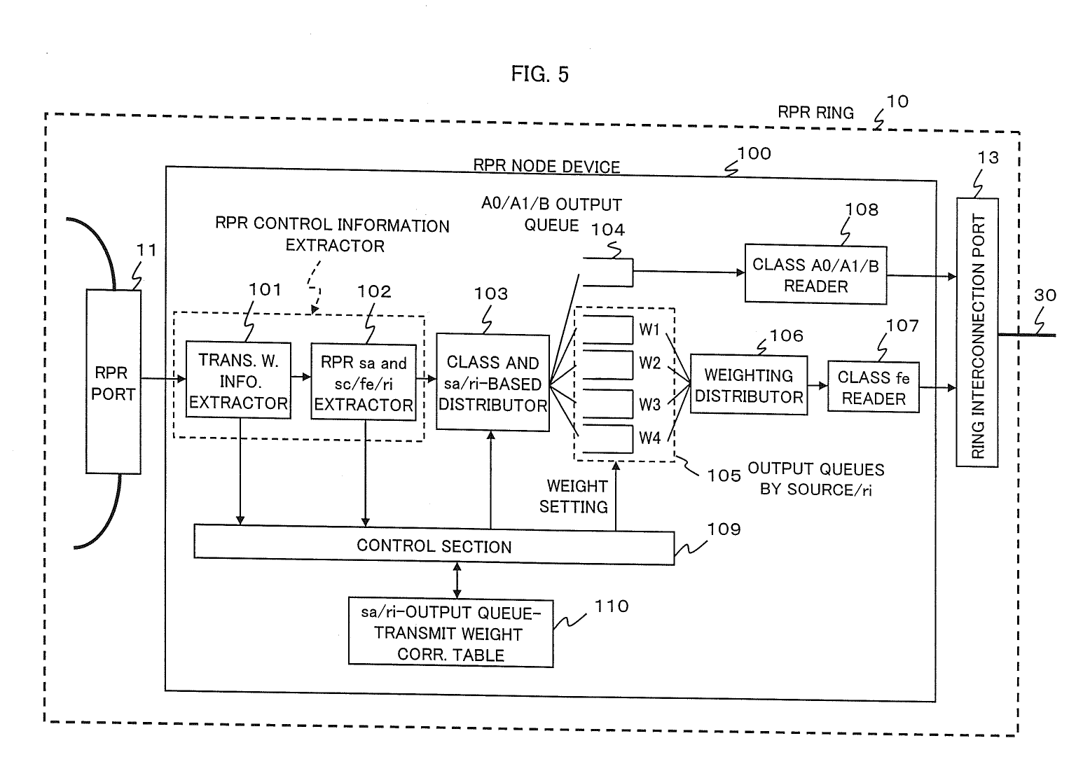

Referring to FIG. 5, the RPR node device 100 is provided with a RPR control information extractor composed of a transmit weight information extractor 101 and an RPR sa and sc/fe/ri extractor 102, which are called hereinafter a first extractor 101 and a second extractor 102, respectively.

The RPR node device 100 is further provided with a class and source/ri-based distributor 103, A0/A1/b output queue 104, by-source/ri output queues 105, a weighting distributor 106, a class fe reader 107, a class A0/A1/B reader 108, a control section 109 and a source/ri-queue-weight correspondence table 110. The first extractor 101 is connected to the RPR port 11, and the class fe reader 107 and the class A0/A1/B reader 108 are connected to the ring interconnection port 13.

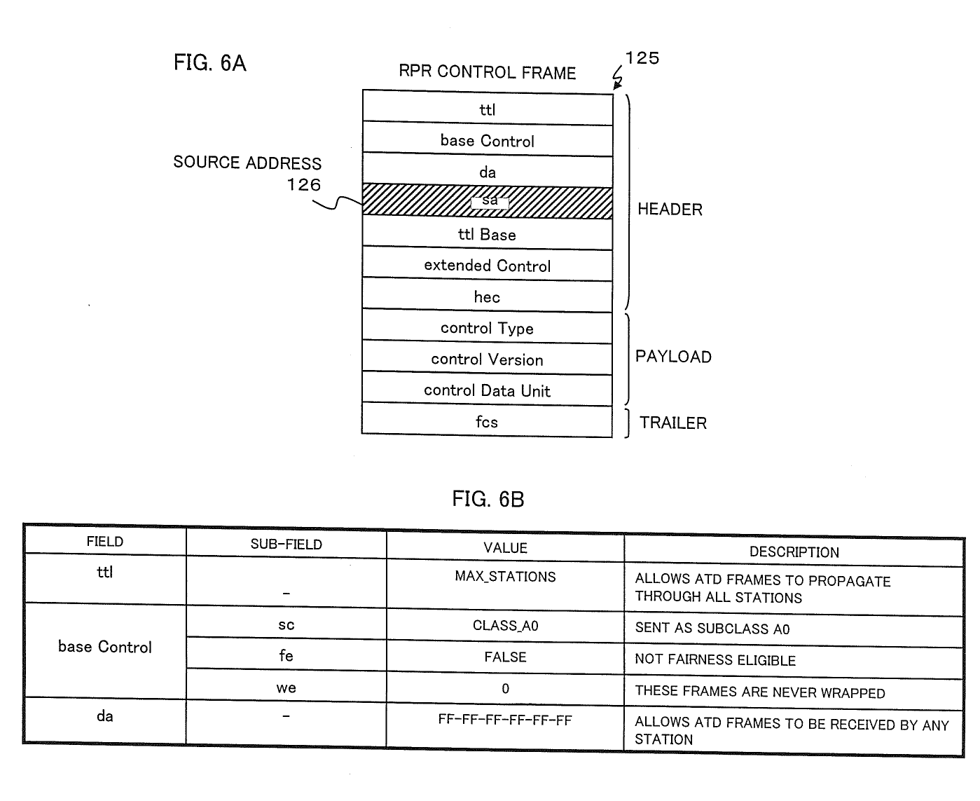

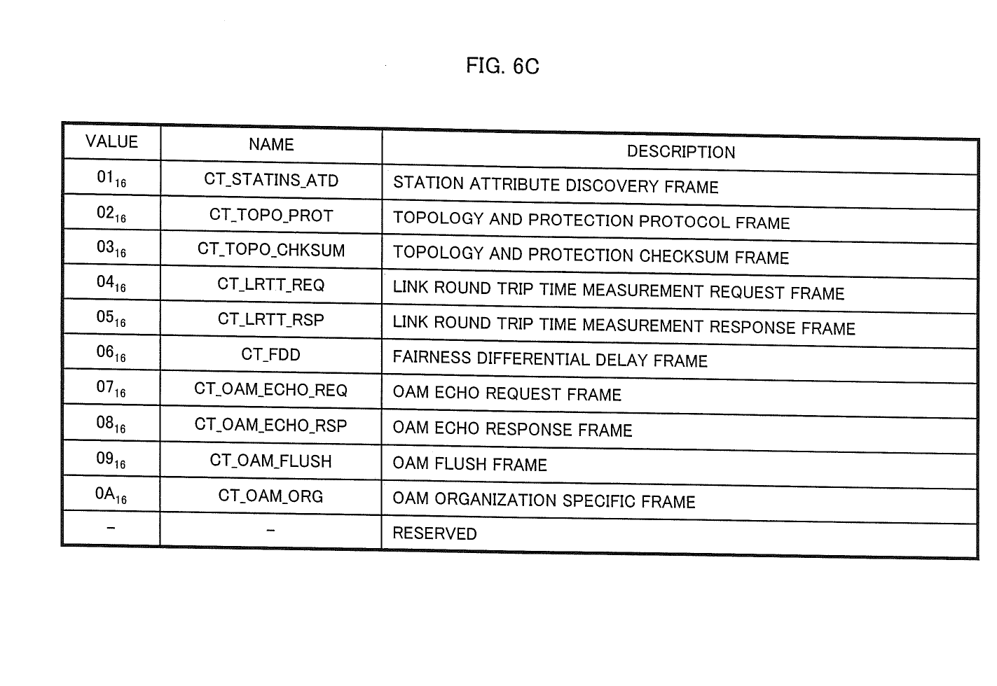

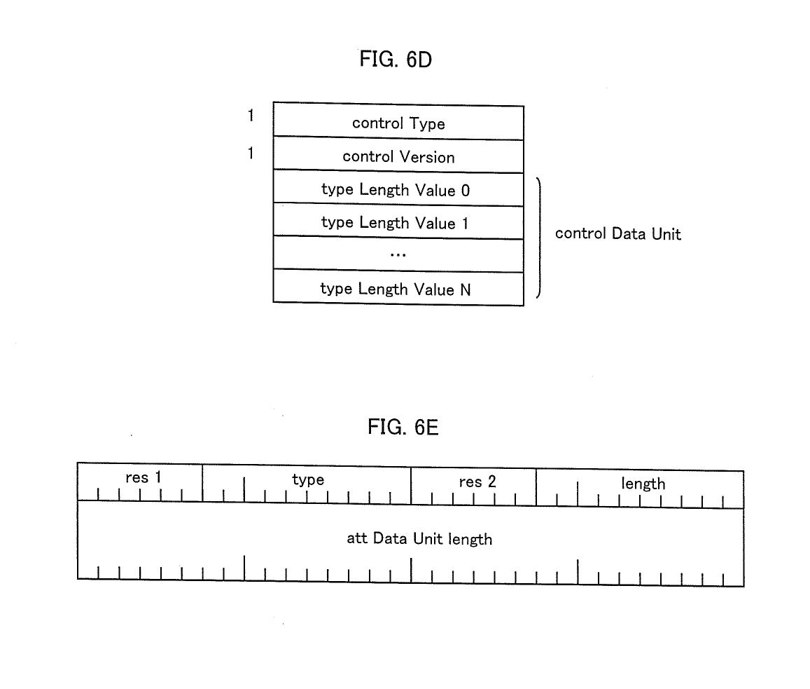

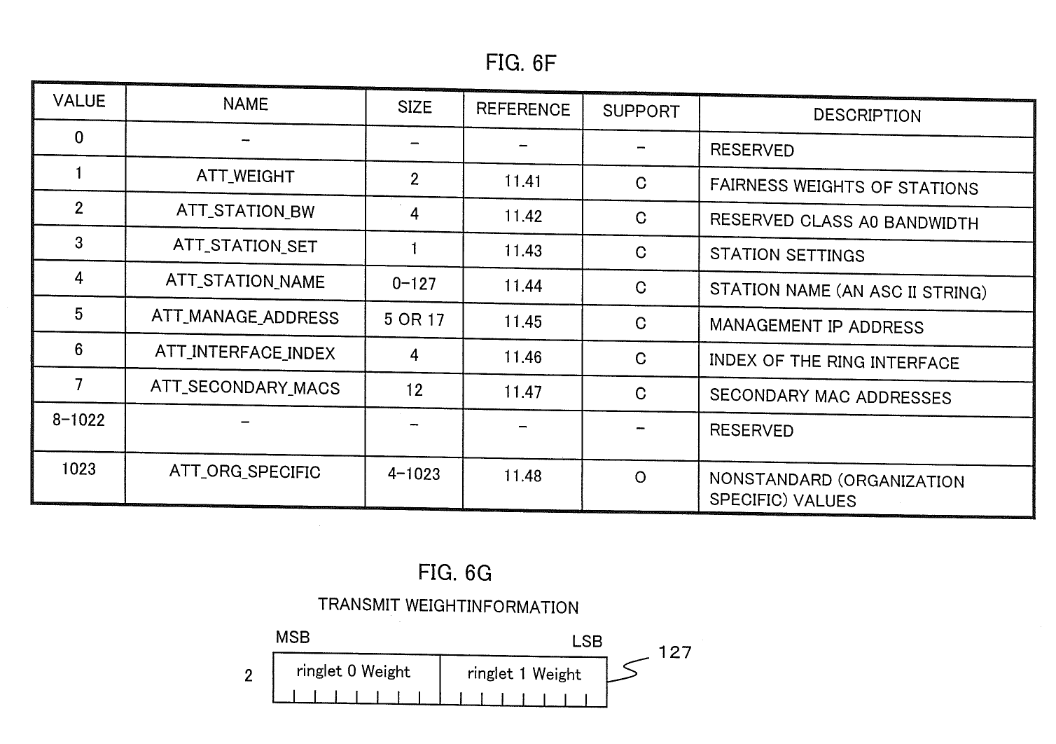

The RPR node device 100 receives packets on the communication traffic that are to be transmitted to another network from an RPR port 11. When having received an RPR control frame 125 (see FIG. 6A) transferred over the RPR ring 10, the first extractor 101 extracts its source address (sa) 126 (see FIG. 6A) and transmit weight information 127 (see FIG. 6G) from the RPR control frame 125.

Incidentally, an RPR control frame 125 is shown in FIG. 6A. Examples of the information in a “ttl” field, a “base Control” field, and a “da” field in the header of the RPR control frame 125 are shown in FIG. 6B. Examples of the information in a “control Type” field in the payload of the RPR control frame 125 are shown in FIG. 6C. Examples of the information in a “control Data Unit” field in the payload of the RPR control frame 125 are shown in FIG. 6D. An example of the information in a “type Length Value” field of the “control Data Unit” field is shown in FIG. 6E. Definition values of “Type” in the “type Length Value” field are shown in FIG. 6F. An example of the information in an “att Data Unit” field of the “control Data Unit” field is shown in FIG. 6G. The example shown in FIG. 6G corresponds to the transmit weight information 127.

The transmit weight information 127 is used for fairness control for fairness among RPR node devices within the RPR ring 10, and notifies this information to the control section 109 which sets transmit weights by referring to the table 110 of correspondence between transmit weights and output queues by RPR source address (sa) and ring transmit direction (ri: ringlet ID).

Based on the transmit weight information 127 notified from the first extractor 101, the control section 109 sets transmit weights respectively for output queues 105, which are provided according to source node devices and ring transmit directions (source/ri). In FIG. 5, the transmit weights W1-W4 for respective output queues 105 are set on a source-by-source and ri-by-ri basis by the control section 109 inputting the transmit weight information from the first extractor 101.

Further, the first extractor 101 outputs the received packet to the second extractor 102 which extracts RPR source address (sa) and information of sc (service class), fe (fairness eligible), and ri (ringlet ID) sub-fields. The second extractor 102 outputs the received packet to the class and source/ri-based distributor 103 which distributes packets to the A0/A1/B output queue 104 and the output queues 105 according to class and source/ri.

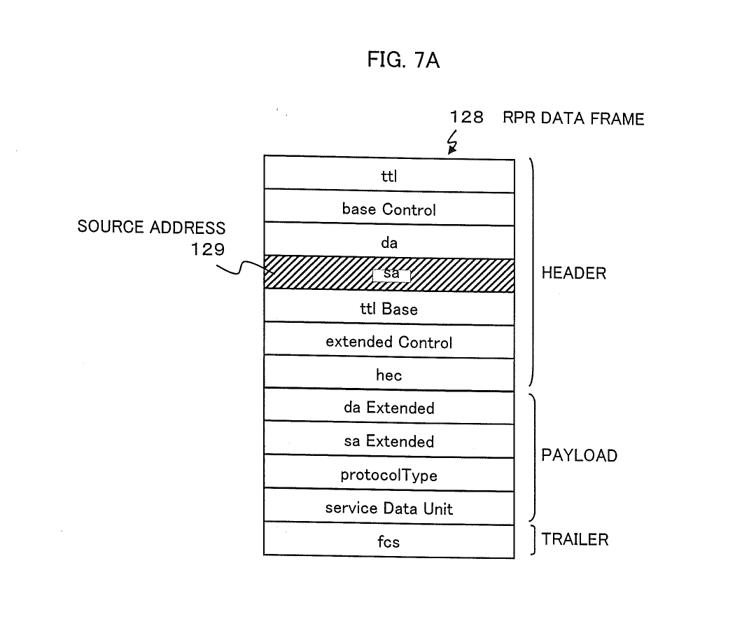

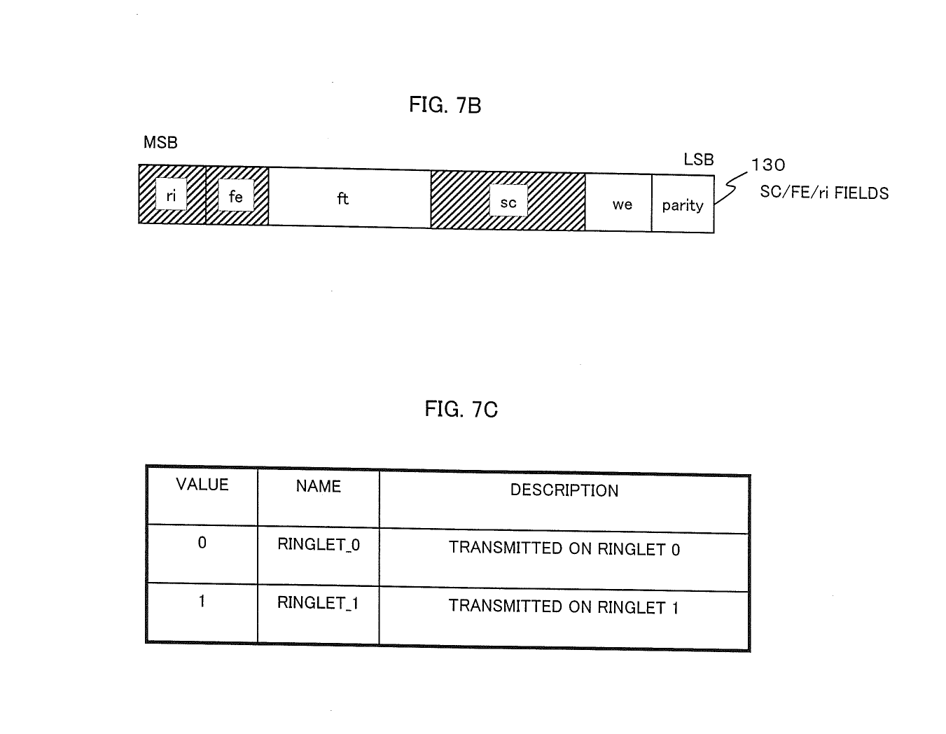

When outputting the received packet to the class and source/ri-based distributor 103, the second extractor 14 extracts the source address (sa) 129 from the header of an RPR data frame 128 shown in FIG. 7A and further extracts a service class (sc), a fairness bit (fe), and a ring transmit direction (ri) from the sc, fe, and ri sub-fields 130, as shown in FIG. 7B, of the “base Control” field. Incidentally, exemplary values of the ring transmit directions (ri) are shown in FIG. 7C.

The class and source/ri-based distributor 103 outputs the received packet to one of the output queues 105 or the output queue 104. The output queue 104 is a queue for packets with any one of service classes A0, A1, and B. The class and sa/ri-based distributor 103 distributes packets, based on the service class (sc), source address (sa), and ring transmit direction (ri) extracted by the second extractor 102.

As for the traffic input to the in the A0/A1/B output queue 104, the class A0/A1/B reader 20 reads the traffic from the A0/A1/B output queue 104 according to output timing and outputs it to the RPR ring interconnecting point 30 through the ring interconnection port 13. As for the traffic input to the output queues 105, after an output amount is weighted by the weighting distributor 106 appropriately for each queue, the traffic is timed, by using the class fe reader 107, to be output to the RPR ring interconnecting point 30 through the ring interconnection port 13.

As described above, according to the present embodiment, using the control information and frame header information according to the RPR protocol, the RPR functionality can be extended, whereby the fairness control of communication data among RPR node devices defined by the RPR standards is accomplished even at a ring interconnecting interface.

The traffic transfer over the individual RPR ring in FIG. 4 and the fairness control performed within each RPR ring are well know to those skilled in the art and are not directly related to the present invention, and therefore description thereof will be omitted.

### 1.2) Fairness Control of Traffic

Next, the operation of the fairness control of traffic will be described. Each of the RPR node devices NODE1 to NODE4 on the RPR ring 10 writes the transmit weight information of its own onto an RPR control frame 125 and exchanges it with the other RPR node devices on the same RPR ring.

When the RPR node device 100 accommodating the ring interconnecting point 30 between the RPR rings 10 and 20 has received the RPR control frame 125, the first extractor 101 extracts the transmit weight information 127 for each other RPR node device from the received RPR control frame 125, extracts the address of the corresponding RPR node device from the source address (sa) field 126 in the RPR control frame 125, and notifies the extracted information to the control section 109.

The control section 109 immediately sets the weights W1-W4 of the output queues 105 according to the transmit weight information received from the first extractor 101 so as to use the weight information set on each RPR node device for fairness control.

When the RPR node device 100 transmits a data frame, the second extractor 102 extracts the RPR source address, ri information, sc information, and fe information from the overhead of the RPR data frame 128 to be transmitted to the other RPR ring 20. If the traffic has the sc/fe information that allows the traffic to be eligible for fairness control, the traffic is output to an appropriate one of the output queues 105 by source address and ri by the class and sa/ri-based distributor 103.

Thereafter, frame transmission according to fairness weight rates is performed through the control by the output queues 105, weighting distributor 106, and class fe reader 107.

On the other hand, the class and sa/ri-based distributor 103 outputs communication data to the A0/A1/B output queue 104, based on the source RPR node device information, sc information, and fe information, when the communication data has the service class of A0, A1 or B and a fairness bit of “0,” which indicates that the traffic is not eligible for fairness control. The class A0/A1/B reader 20 outputs the communication data queued in the output queue 104 to the RPR ring interconnecting point 30 through the ring interconnection port 13.

In this event, the class fe reader 107 outputs communication data to the ring interconnection port 13 at the timing when the class A0/A1/B reader 20 is not outputting communication data to the ring interconnection port 13.

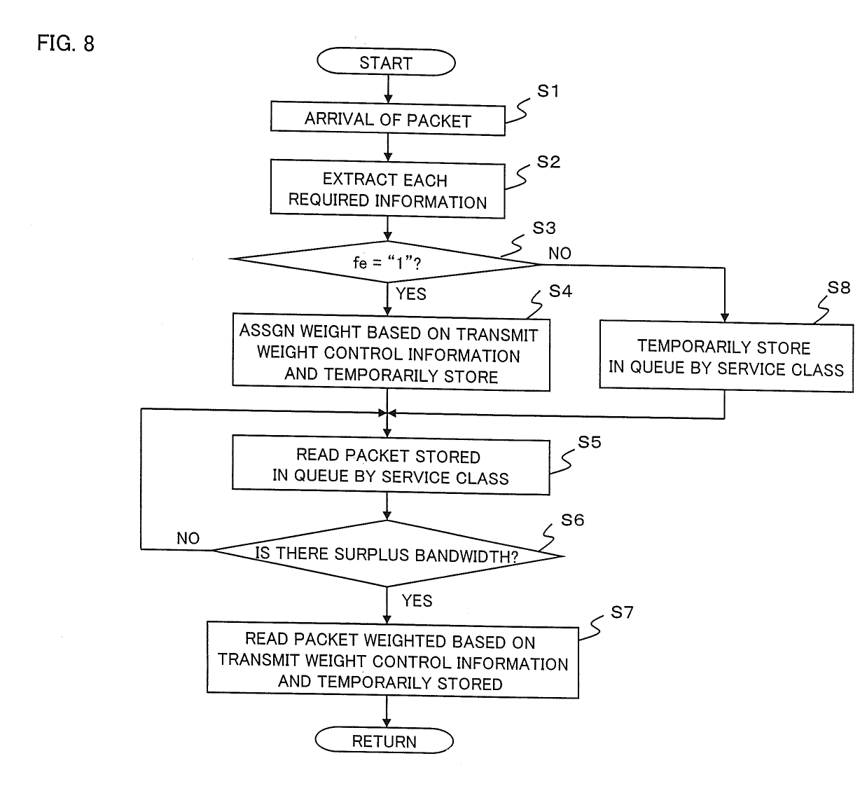

The above-described operation is also shown in FIG. 8 as a flow chart. When a packet arrives at the RPR node device 100 (step S1), the first extractor 101 and the second extractor 102 extract the respective information (transmit weight information 127, source address (sa), service class (sc), fairness bit (fe), and ring transmit direction (ri)) (step S2).

When the fairness bit (fe) is “1” (step S3: YES), the packet is weighted based on the transmit weight information 127 and temporarily stored in one of the output queues 105 (step S4). When the fairness bit (fe) is “0” (step S3: NO), the packet is temporarily stored by service class in the A0/A1/B output queue 104 (step S8). Then, packets temporarily stored by service class in the A0/A1/B output queue 104 are read out first (step S5), and, if there is a surplus bandwidth (step S6: YES), packets in the output queues 105 are read out (step S7). In other words, as for reading packets, the A0/A1/B output queue 104 takes priority over the output queues 105.

The RPR node device 100 as described above may be implemented by running respective programs on a program-controlled processor such as a CPU.

### 2. Second Exemplary Embodiment

A second exemplary embodiment of the present invention will be described. Although the basic configuration of this exemplary embodiment is similar to the above-described first exemplary embodiment, a modification is made to the output queues.

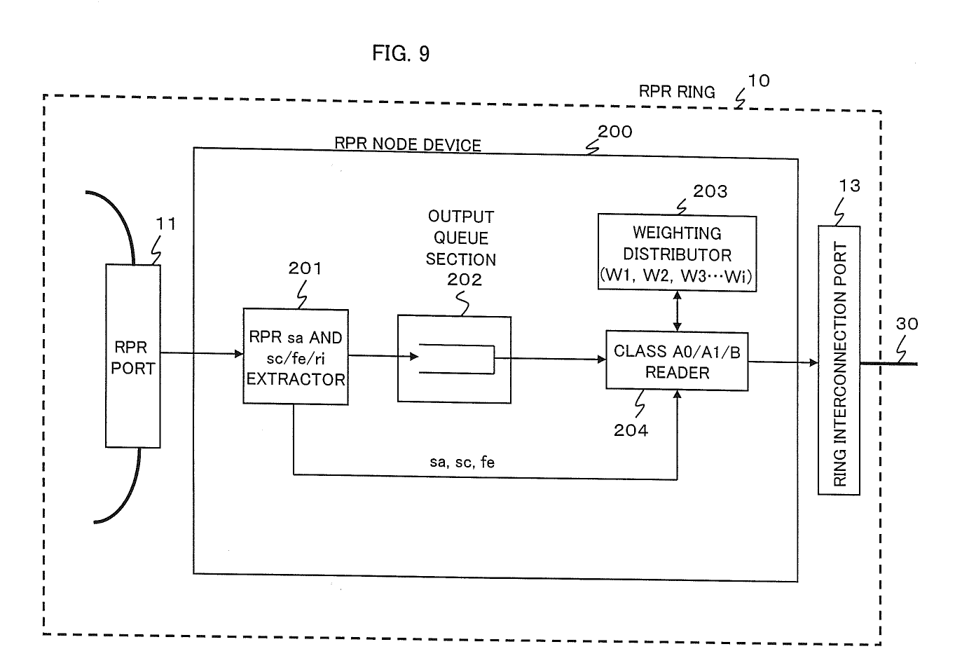

FIG. 9 shows the configuration of an RPR node device 200 according to the second exemplary embodiment. Referring to FIG. 9, the configuration of the output queues to store communication data according to the first exemplary embodiment is modified to obtain a single output queue, whereby the total quantity of queues is reduced. In the communication traffic on an RPR ring 10, when traffic to be transmitted from the RPR ring 10 to another RPR ring 20 is input to the RPR node device 200, an RPR sa and sc/fe/ri extractor 201 extracts the RPR source address (sa), service class (sc), fairness bit (fe), and ring transmit direction (ri) information from input packets.

The RPR source address which has been given in the RPR header of the packet is extracted to identify a source RPR node device. The service class (sc) information has been similarly given in the RPR header while the traffic has been transported over the RPR ring 10, and the fairness bit (fe) information indicates whether or not the traffic is eligible for fairness control. The RPR sa and sc/fe/ri extractor 201 stores all communication data into the output queue section 202 and outputs the RPR source address of the communication data, as well as the sc and fe information, to a class A0/A1/B reader 204.

Among the communication data stored in the output queue section 202, the class A0/A1/B reader 204 outputs those having any one of the service classes A0, A1, and B to an RPR ring interconnecting point 30 through a ring interconnection port 13.

Communication data identified as being eligible for RPR fairness control is subjected to weighting processing by a weighting distributor 203, by which a read-out amount of communication data is distributed into one of weights W1, W2, W3, . . . Wi (i is the number of source node devices in the RPR ring 10), which are previously set on source RPR node devices respectively. Thereafter, a communicable fraction of the communication data according to the weights is output to the RPR ring interconnecting point 30 through the ring interconnection port 13.

As described above, according to the second exemplary embodiment of the present invention, the operation of reading from the output queue section 202 is performed by the class A0/A1/B reader 204 and the weighting distributor 203 while the traffic eligible for fairness control is being weighted. Accordingly, the advantage can be obtained that the total quantity of the output queue 202 can be reduced in comparison with that of the output queues 105 in FIG. 5.

In the present exemplary embodiment, the physical configuration of the output queue section 202 may be changed so that two queues, an A0/A1/B class output queue and an fe class output queue, are provided in the output queue section 202.

The RPR node device 200 as described above may be implemented by running respective programs on a program-controlled processor such as a CPU.

### 3. Variations

Note that, although the RPR rings 10 and 20 are interconnected through the single ring interconnecting point 30 in the above-described exemplary embodiments, a plurality of interconnecting points may be provided between the adjacent RPR node devices 10 and 20. Moreover, the connection is not limited to only between the RPR node devices NODE4 and NODE22.

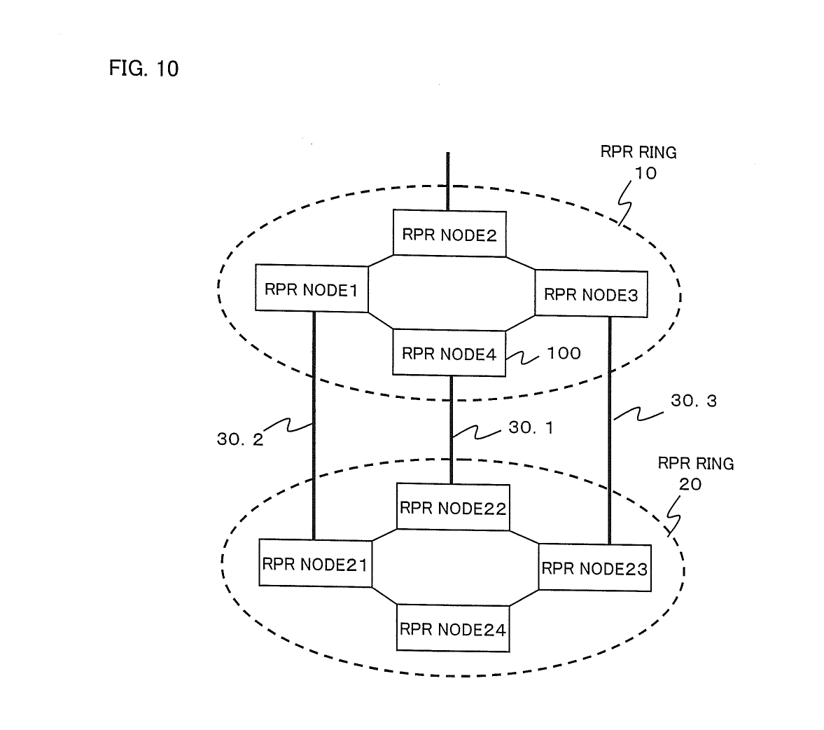

As shown in FIG. 10, it is also possible to adopt a configuration in which a plurality of interconnecting points are provided, such as a configuration in which, in addition to the ring interconnecting point 30.1, an interconnecting point 30.2 or 30.3 is also provided between the RPR node devices NODE1 and NODE 21 or between the RPR node devices NODE3 and NODE23.

In addition, regarding the output queues 104 and 105, the configuration is not limited to physically separated independent queues as described above. It is also possible to configure them such that only a single physical queue is provided and output control is performed by using virtual output queues.

### 4. Various Aspects

As described before, the main object of the present invention is to provide an RPR node device, a fairness control method, and an RPR communications system which can guarantee the fairness of communication traffic that is guaranteed within an RPR ring, even at a ring interconnection in a communications network in which a plurality of RPR ring systems are interconnected.

According to the present invention, in order to perform fairness control on packets received from a source RPR ring, various parameters required for the fairness control (for example, source address, service class (sc), fairness bit (fe), transmit ring direction (ri)) are extracted. Output queues are provided by service class, source or transmit ring direction based on these parameters. Packets are read out from the output queues to a destination RPR ring by service class, source or transmit ring direction.

In this manner, according to the present invention, traffic requiring fairness control on communication in the RPR ring can be transmitted while performing fairness control at the RPR ring interconnecting point. Accordingly, even in a communication system in which a plurality of RPR rings are connected, communication can be made while maintaining traffic fairness similar to that performed in individual RPR ring.

In other words, a RPR node device according to the present invention is characterized by comprising: an RPR control information extracting means for extracting information including transmit weight information used for fairness control as well as source address, service class, fairness bit and ring transmit direction, from RPR control information of an arrival packet; a class-based output queue for temporarily storing packets with the fairness bit being “0” by service class; a source- and ring transmit direction-based output queue for temporarily storing packets with the fairness bit being “1” by source device and ring transmit direction while weighting based on the transmit weight information; and a means for reading packets from the class-based queue taking priority over the source- and ring transmit direction-based output queue.

According to another aspect of the present invention, a fairness control method according to the present invention is characterized by comprising: extracting information including transmit weight information used for fairness control as well as source address, service class, fairness bit and ring transmit direction, from RPR control information of an arrival packet; temporarily storing packets with the fairness bit being “0” in a class-based output queue by service class; temporarily storing packets with the fairness bit being “1” in a source- and ring transmit direction-based output queue by source device and ring transmit direction while weighting based on the transmit weight information; and reading packets from the class-based queue taking priority over the source- and ring transmit direction-based output queue.

From the view point of RPR communication system, a RPR communication system may include the RPR node device according to the present invention.

From the view point of computer program, the RPR node device or the fairness control method according to the present invention may be implemented by installing programs onto a general-purpose information processing device.

From the view point of a recording media recording computer program, the RPR node device or the fairness control method according to the present invention may be implemented by installing programs recorded in the recording media onto a general-purpose information processing device.

It should be noted that the program as described above may include not only a program which is directly executable on the general-purpose information processing device but also a program which is executable after installed on a storage device such as a hard disk drive. In addition, the program as described above may include a compressed or encrypted program.

Accordingly, the fairness of communication traffic guaranteed within an RPR ring is guaranteed also at a ring interconnection. Transmit weight information used for fairness control is extracted from RPR control information in an arrival packet. In addition to this transmit weight information, a source address, a service class, a fairness bit, and a ring transmit direction are also extracted. If the packet has a fairness bit of “0,” the packet is temporarily stored in an output queue by service class. If the packet has a fairness bit of “1,” the packet is weighted by source and ring transmit direction, based on the transmit weight information, and is temporarily stored in an output queue by source and ring transmit direction. Reading of packets from the output queue by service class is performed prior to reading of packets from the output queue by source and ring transmit direction.

According to the present invention, the following effects can be achieved.

A first effect is that fairness control as performed within an RPR ring can also be accomplished at an RPR ring interconnecting point in a network in which a plurality of RPR rings are interconnected, because an RPR node device located at the RPR ring interconnecting point performs fairness control on data traffic that is eligible for the fairness control defined by the RPR standards.

A second effect is that fairness control of traffic can be accomplished without changing control schemes defined in individual RPR rings, because fairness control functionality is provided only to RPR node devices located at an RPR ring interconnecting point.

According to the present invention, in a network in which a plurality of RPR rings are interconnected, fairness control as performed within an RPR ring can also be performed at an RPR ring interconnecting point. Moreover, the fairness control of traffic can be accomplished without changing control schemes defined in individual RPR rings. Thus, the present invention can be used to enhance the quality of service provided to users.

The present invention may be embodied in other specific forms without departing from the spirit or essential characteristics thereof. The above-described exemplary embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A device for transferring packets from a first RPR (Resilient Packet Ring) network to a second RPR network, wherein the first and second RPR networks are interconnected through the device, comprising:
an information extractor for extracting RPR control information including transmit weight information used for fairness control from RPR control information of a packet received from the first RPR network;
a first queue section for temporarily storing first packets ineligible for fairness control by service class;
a second queue section for temporarily storing second packets eligible for fairness control by source device and ring transmit direction on the first RPR network, wherein transmission ratios of the second packets are weighted according to the transmit weight information extracted from the second packets; and
a packet reader for reading packets from the first queue section taking priority over the second queue section.

2. The device according to claim 1, wherein the second queue section comprises a plurality of output queues each having different weights on output amounts, wherein the weights are set based on the transmit weight information.

3. The device according to claim 1, further comprising a distributor for distributing the received packet to an appropriate queue of the first and second queue sections depending on whether it is eligible for fairness control and on the transmit weight information.

4. The device according to claim 1, wherein the packet reader first reads out first packets temporarily stored in the first queue section and, if there is a surplus bandwidth, reads out the second packets temporarily stored in the second queue section.

5. A fairness control method of packets transmitted from a first RPR (Resilient Packet Ring) network to a second RPR network, wherein the first and second RPR networks are interconnected through the device, comprising:
extracting RPR control information including transmit weight information used for fairness control from RPR control information of a packet received from the first RPR network;
temporarily storing first packets ineligible for fairness control by service class in a first queue section;
temporarily storing second packets eligible for fairness control by source device and ring transmit direction on the first RPR network in a second queue section, wherein transmission ratios of the second packets are weighted according to the transmit weight information extracted from the second packets; and
reading packets from the first queue section taking priority over the second queue section.

6. The fairness control method according to claim 5, wherein the second queue section comprises a plurality of output queues each having different weights on output amounts, wherein the weights are set based on the transmit weight information.

7. The fairness control method according to claim 5, further comprising:
distributing the received packet to an appropriate queue of the first and second queue sections depending on whether it is eligible for fairness control and on the transmit weight information.

8. The fairness control method according to claim 5, wherein the first packets temporarily stored in the first queue section are first read out and, if there is a surplus bandwidth, the second packets temporarily stored in the second queue section are read out.

9. A RPR communications system comprising a first RPR (Resilient Packet Ring) network to a second RPR network, wherein a RPR node device of the first RPR network interconnects the first RPR network to the second RPR network, wherein the RPR node device comprises:
an information extractor for extracting RPR control information including transmit weight information used for fairness control from RPR control information of a packet received from the first RPR network;
a first queue section for temporarily storing first packets ineligible for fairness control by service class;
a second queue section for temporarily storing second packets eligible for fairness control by source device and ring transmit direction on the first RPR network, wherein transmission ratios of the second packets are weighted according to the transmit weight information extracted from the second packets; and
a packet reader for reading packets from the first queue section taking priority over the second queue section.

10. A computer-readable program instructing a computer of a RPR (Resilient Packet Ring) node device to transfer packets from a first RPR network to a second RPR network, wherein the first and second RPR networks are interconnected through the RPR node device, wherein the program functions the computer as the RPR node device by:
extracting RPR control information including transmit weight information used for fairness control from RPR control information of a packet received from the first RPR network;
temporarily storing first packets ineligible for fairness control by service class in a first queue section;
temporarily storing second packets eligible for fairness control by source device and ring transmit direction on the first RPR network in a second queue section, wherein transmission ratios of the second packets are weighted according to the transmit weight information extracted from the second packets; and
reading packets from the first queue section taking priority over the second queue section.

11. A device for transferring packets from a first RPR (Resilient Packet Ring) network to a second RPR network, wherein the first and second RPR networks are interconnected through the device, comprising:
an information extractor for extracting RPR control information from RPR control information of a packet received from the first RPR network;
a queue section for temporarily storing packets to be sent to the second RPR network, which are received from the first RPR network;
a weighting distributor for weighting transmission ratios of first packets eligible for fairness control stored in the queue section according to predetermined weights assigned to respective ones of RPR node devices on the first RPR network; and
a packet reader for reading second packets ineligible for fairness control from the queue section taking priority over the first packets eligible for fairness control.
